(19) United States
(12) Patent Application Publication
(10) Pub. No.: US 2018/0044145 A1
(43) Pub. Date: Feb. 15, 2018

(54) LIFTING ARRANGEMENT

(71) Applicant: MHWIRTH AS, KRISTIANSAND (NO)

(72) Inventor: ERLEND ANGEL-DALANE, FLEKKEROEY (NO)

(73) Assignee: MHWIRTH AS, KRISTIANSAND (NO)

(21) Appl. No.: 15/557,128

(22) PCT Filed: Feb. 3, 2016
(86) PCT No.: PCT/NO2016/050017

§ 371 Date: Sep. 11, 2017

(30) Foreign Application Priority Data
Mar. 12, 2015 (NO) 20150318

(51) Int. Cl. B66C 15/02; B66D 5/02; F15B 13/042; F15B 11/00; F15B 13/02

(52) U.S. Cl. CPC B66C 15/02; F15B 11/003; F15B 13/024; F15B 13/0422; B66D 5/026; E21B 19/02

(57) ABSTRACT

A back-up load retention system includes a retention line which is connected to a load, a counterweight unit which is connected to the retention line, and a double-acting hydraulic cylinder which is connected to the counterweight unit. The counterweight unit maintains a tension force in the retention line. The double-acting hydraulic cylinder brakes and/or stops the load in a case of a failure in a main lifting system.

### CROSS REFERENCE TO PRIOR APPLICATIONS

This application is a U.S. National Phase application under 35 U.S.C. § 371 of International Application No. PCT/NO2016/050017, filed on Feb. 3, 2016 and which claims benefit to Norwegian Patent Application No. 20150318, filed on Mar. 12, 2015. The International Application was published in English on Sep. 15, 2016 as WO 2016/144186 A1 under PCT Article 21(2).

### FIELD

The present invention relates to a back-up load retention system, and to a lifting system comprising a main lifting system and the back-up load retention system. The present invention is particularly suitable for use in offshore applications, but may also be used in onshore applications.

### BACKGROUND

Many lifting operations, in particular those in offshore applications such as on drilling rigs or petroleum vessels, have stringent safety requirements because the consequences of accidents can be significant both economically and in relation to personnel safety. Several examples exist where the breakage or malfunction of a lifting system has led to machines or loads being dropped, with severe economic consequences due to equipment and structural damage, and risk of personnel life.

Lifting equipment is exposed to extremely harsh operating conditions, in particular in offshore applications. A continuous need therefore exists for solutions that can improve safety and reduce the risk of incidents, and, if a malfunction or incident occurs, reduce or eliminate the consequences of that incident.

### SUMMARY

An aspect of the present invention is to improve safety in lifting operations and to remedy or eliminate shortcomings of known systems.

In an embodiment, the present invention provides a back-up load retention system which includes a retention line configured to be connected to a load, a counterweight unit connected to the retention line, and a double-acting hydraulic cylinder connected to the counterweight unit. The counterweight unit is configured to maintain a tension force in the retention line. The double-acting hydraulic cylinder is configured to at least one of brake and stop the load in a case of a failure in a main lifting system. The back-up load retention system of the present invention reduces or eliminates the risk of a load falling if a failure or damage to the main lifting system occurs.

### BRIEF DESCRIPTION OF THE DRAWINGS

The present invention is described in greater detail below on the basis of embodiments and of the drawings in which:

FIG. 1 shows an overview of a lifting system comprising a main lifting system and a back-up load retention system;

FIG. 2 shows a back-up load retention system;

FIG. 3 shows a back view of the load retention system shown in FIG. 2;

FIG. 4 shows a side view of the load retention system shown in FIG. 2;

FIG. 5 shows a front view of the load retention system shown in FIG. 2;

FIG. 6 shows a top view of the load retention system shown in FIG. 2; and

FIG. 7 shows a schematic illustration of the system hydraulic arrangement.

### DETAILED DESCRIPTION

The present invention relates to a back-up load retention system comprising a retention line connectable to a load, a counterweight unit connected to the retention line, the counterweight unit being adapted to maintain a tension force in the retention line, and a double-acting hydraulic cylinder connected to the counterweight unit, whereby the double-acting hydraulic cylinder is configured to brake and/or stop the load in the case of a failure in a main lifting system of the load. In an offshore application, the load may, for example, be a length of drilling string, a pipe handling machine, or any other item being lifted in a petroleum-related operation

The retention line can, for example, be connected to the counterweight unit via a plurality of sheaves. The plurality of sheaves can, for example, be arranged to provide a gearing ratio between a weight of the counterweight unit and the tension force in the retention line. This advantageously allows for adjustment of the force acting on the load from the back-up load retention system in relation to the weight of the counterweight unit, as well as the distance travelled by the counterweight unit in relation to the load.

In an embodiment of the present invention, a motion of the counterweight unit is supported by one or more guide rails.

The back-up load retention system can, for example, further comprise a hydraulic circuit connecting a rod side and a piston side of the double-acting hydraulic cylinder, wherein the hydraulic circuit forms at least one connection between the rod side and the piston side. A connection is understood as an independent fluid line connecting the rod side with the piston side of the double-acting hydraulic cylinder. A number of connections may alternatively have a common outlet/inlet from the piston side and the rode side, respectively.

The hydraulic circuit can, for example, comprise one or more flow regulators arranged in at least one of the connections. The flow regulator may be any flow regulator suitable for closing, opening, choking or partly opening/closing a connection such as a fluid line.

In an embodiment of the present invention, the flow regulator comprises a valve adapted to isolate the rod side from the piston side in the event of an uncontrolled falling of the load. This advantageously permits the connection between the rod side and piston side of the hydraulic cylinder to be open during normal operation with the ability to engage upon identification of a falling load.

The flow regulator can, for example, comprise at least one flow fuse adapted to close or restrict at least one of the connections between the rod side and the piston side upon a hydraulic flow rate through the at least one flow fuse reaching a pre-determined threshold value.

In an embodiment of the present invention, at least one flow fuse is provided and adapted to close or restrict a hydraulic connection between the rod side and the piston side upon a hydraulic flow rate through the at least one flow fuse reaching a pre-determined value. This advantageously limits the maximum speed at which the system operates.

In an embodiment of the present invention, the flow regulator can, for example, comprise a hydraulic relief valve adapted to open at least one of the connections between the rod side and a piston side when a hydraulic pressure difference between the rod side and the piston side exceeds a pre-determined threshold value. This advantageously prevents damage to the hydraulic system resulting from over-pressure, while still maintaining the functionality of the system once the pressure is normalized.

In an embodiment of the present invention, the flow regulator can, for example, comprise a manually operable valve permitting opening of at least one of the connections between the rod side and the piston side of the double-acting hydraulic cylinder. This advantageously allows for a manual lowering of a hanging load secured by the back-up load retention system.

In an embodiment of the present invention, the flow regulator can, for example, comprise at least one one-way valve permitting opening of at least one of the connections between the rod side and the piston side of the double-acting hydraulic cylinder.

It is to be noted that even though the arrangement and positioning of various flow regulators have been described and disclosed in a specific connection between the rod side and the piston side of the hydraulic cylinder, it should be clear that the various kinds of flow regulators can, for example, be arranged in the same connection or in different connections, and/or alone or in combination with other flow regulators.

The present invention also provides a lifting system comprising a main lifting system, a back-up load retention system according to any of the aspects identified above, wherein both the main lifting system and the back-up load retention system are connectable to the same load, and wherein the back-up load retention system is configured to brake and/or stop the load in the case of a failure in the main lifting system.

The present invention will be described in greater detail below under reference to the drawings.

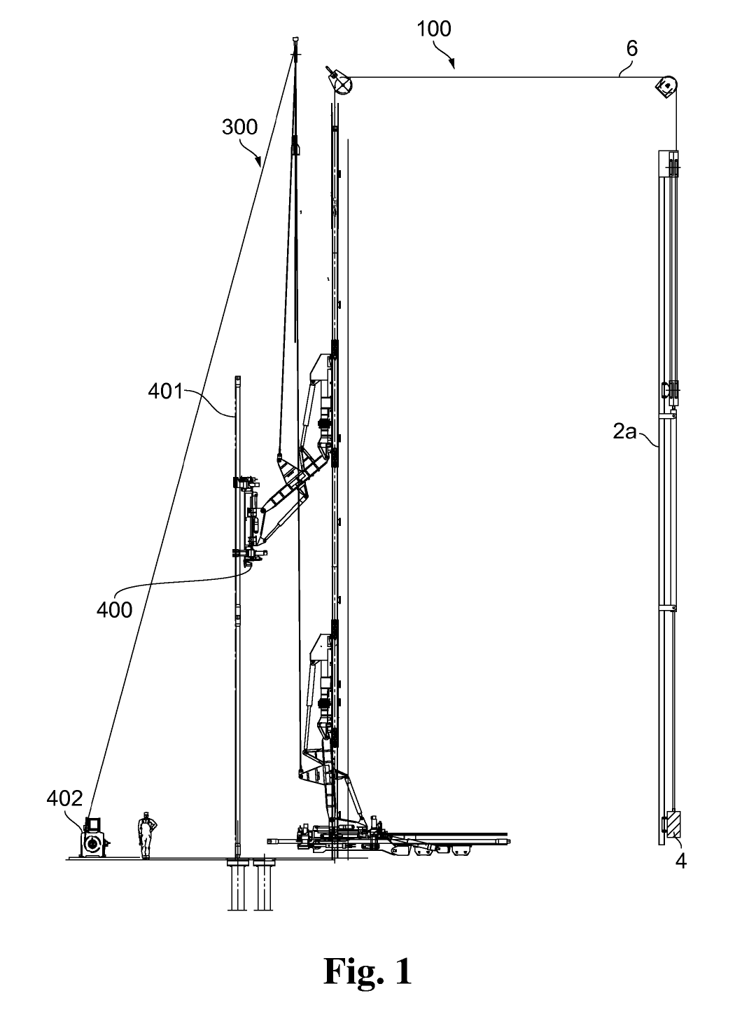

FIG. 1 shows an overview of a lifting system comprising a main lifting system 300 and a back-up load retention system 100. A pipe handling machine 400 supports a pipe 401 in the main lifting system 300, while the back-up load retention system 100 provides for a back-up holding of the pipe 401. A counterweight unit 4 keeps the wire 6 providing the back-up holding in tension.

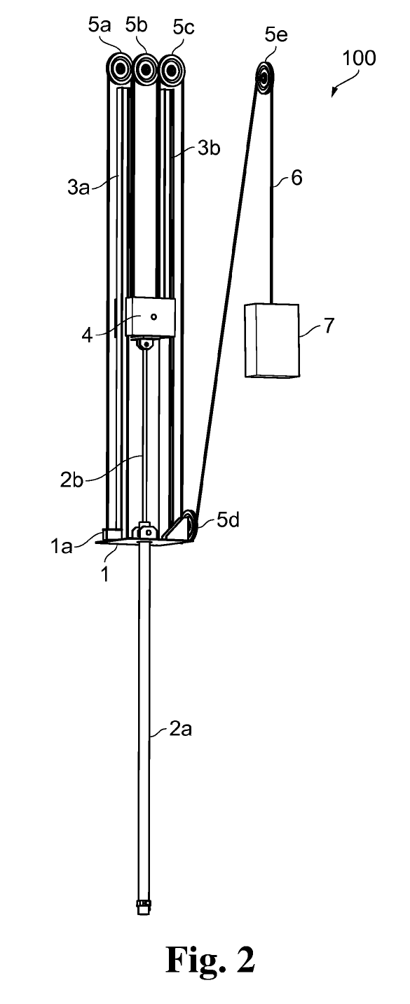

FIG. 2 shows a back-up load retention system 100. The back-up load retention system 100 provides load-drop stopping functionality, i.e., it will keep a vertically lifted load from falling if the main lifting system 300 for the lifted load breaks down or malfunctions. The back-up load retention system 100 is completely independent from the main lifting system 300 (normally a winch (element 402, FIG. 1) that lifts a load, e.g., the winch on a lifting crane), and it connects to the lifted load with a dedicated wire/steel rope.

FIG. 2 shows the back-up load retention system 100 in use. A load 7 is lifted by a main lifting system 300 (not shown), for example, a crane. In an offshore application, the load 7 may, for example, be a length of drilling string, a pipe handling machine, or any other item being lifted in a petroleum-related operation. The back-up load retention system 100 is connected to the load 7 by a wire/wire rope 6, which may be designed to hold substantially the same maximum SWL capacity as the main lifting system 300.

The wire rope 6 is passed over a plurality of sheaves 5a-5e, and through a counterweight unit 4. The end of the wire rope 6 is fixed to a foundation 1 at a fixation point 1a. The counterweight unit 4 is fitted with internal sheaves (not shown) to lead the wire rope 6 therethrough.

The counterweight unit 4 is mounted on top of a hydraulic piston rod 2b, which is part of a hydraulic cylinder 2a. The hydraulic cylinder 2a is arranged with flow fuses and various valves/solenoids (not shown) which will be described further below.

The counterweight unit 4 may also be supported and guided by rails 3a and 3b, for example, by sliding or rolling engagement. The rails may also provide support for one or more of the sheaves 5a-5e.

The back-up load retention system 100 maintains a constant pull in the wire rope 6 via the counterweight unit 4. A gearing ratio between the weight of the counterweight unit 4 and the pulling force in the wire rope 6 can be arranged by design of the number and arrangement of sheaves 5a-5e. For example, FIG. 2 shows a gearing ratio of 4:1, i.e., absent any force on the counterweight unit 4 by the hydraulic cylinder 2a, the wire pulling force will be approximately one fourth of the weight of the counterweight unit 4.

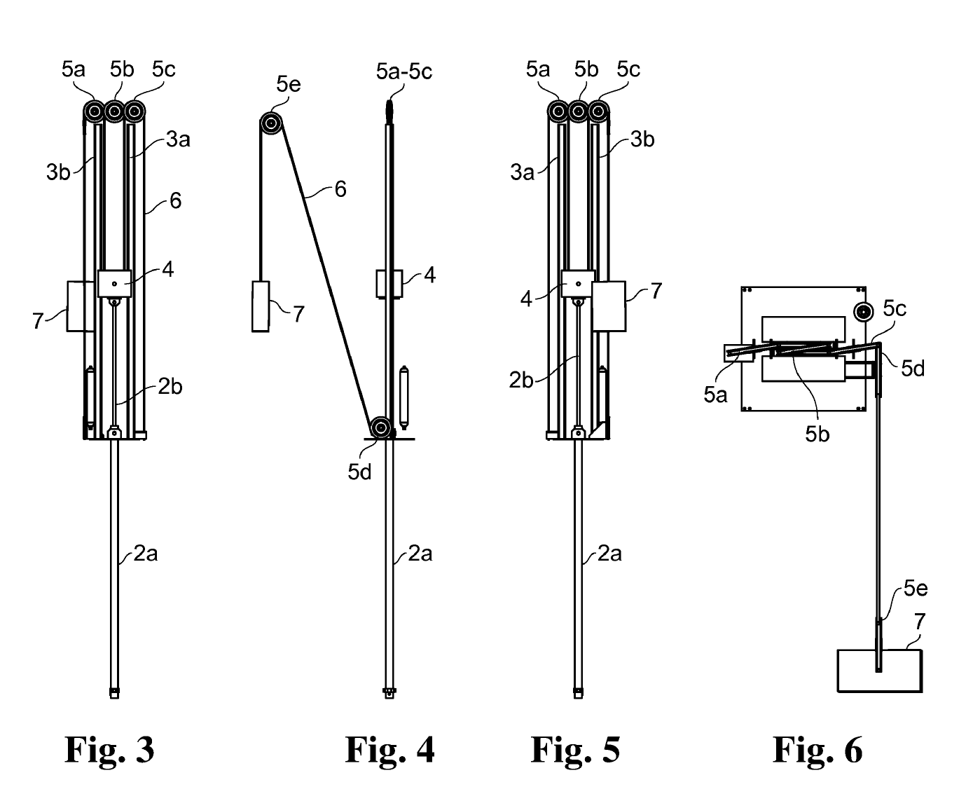

FIGS. 3-6 shows various perspectives of the back-up load retention system 100 according to FIG. 2 and the above description, with FIG. 3 showing a back view, FIG. 4 showing a side view, FIG. 5 showing a front view, and FIG. 6 showing a top view.

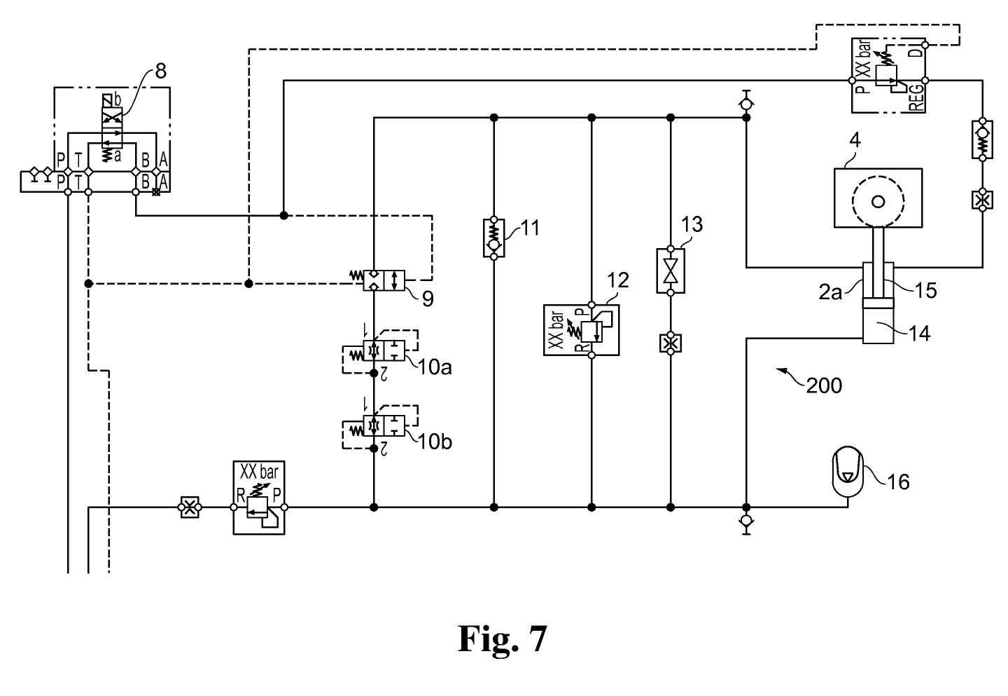

FIG. 7 shows a schematic illustration of the hydraulic cylinder 2a and its hydraulic arrangement. Internally, the hydraulic cylinder 2a comprises a rod side 15 and a piston side 14. The hydraulic circuit 200 forms a number of connections connecting the rod side 15 and the piston side 14 of the (double-acting) hydraulic cylinder 2a.

The hydraulic circuit may comprise one or more flow regulators arranged in at least one of the connections. The flow regulators 8, 9, 10a, 10b, 11, 12, 13 may be any flow regulator which is suitable for closing, opening, choking, partly opening/closing a connection such as a fluid line, and are exemplified in the following.

When the load 7 is lifted by the main lifting system 300 (see FIG. 1), the counterweight unit 4 forces the hydraulic cylinder 2a to retract and thus keeps the wire rope 6 in tension. When the hydraulic cylinder 2a retracts, the oil on the piston side 14 is pushed to the rod side 15. A one-way valve 11 can be arranged in the hydraulic circuit to provide therefor.

When the load 7 is lowered, a solenoid controlled valve 8 pilot-opens directional valve 9 for oil flow from the rod side 15 of the hydraulic cylinder 2a to the piston side 14. This oil must also pass through hydraulic flow fuses 10a and 10b.

Any volume difference in the cylinder chambers between the piston side 14 and the rod side 15 is compensated by an accumulator 16 or, alternatively, any other compensating arrangement.

If the lifted load 7 starts to fall, for example, through a main lift malfunction, the control system will detect this via external instrumentation, and via the solenoid controlled valve 8 and directional valve 9 close the oil flow from the rod side 15 to the piston side 14 of the hydraulic cylinder 2a. This creates a fluid lock, and stops the load 7 from falling.

A ball valve 13 can optionally be arranged between the rod side 15 and the piston side 14. This allows for a load 7 which hangs and is held by the hydraulic cylinder 2a to be emergency lowered via ball valve 13.

In the case of software malfunction, or the control system failing to detect a dropped load, the back-up load retention system 100 is equipped with hydraulic flow fuses 10a, 10b. The hydraulic flow fuses 10a, 10b will allow the load 7 to accelerate to a defined maximum speed, and then close the oil flow from the rod side 15 to the piston side 14 of the double-acting hydraulic cylinder 2a. The load 7 then brakes down and stops.

Excessive pressure build-up can be relieved from the rod side 15 to the piston side 14 of the double-acting hydraulic cylinder 2a via a hydraulic relief valve 12. A sudden overload on the back-up load retention system 100, for example, due to the inertia of a heavy, falling load 7, will create a pressure build up sufficient to open hydraulic relief valve 12, so that the hydraulic cylinder 2a extends. Hydraulic relief valve 12 closes, and the hydraulic cylinder 2a stops when the overload stops.

As will be understood from the above, the back-up load retention system 100 has the advantage that it does not require energizing (electrically or hydraulically) to function, but normally only requires a small oil flow is required to top up or change the hydraulic oil therein. This is to keep a required cleanliness level in the oil.

The present invention is herein described in non-limiting embodiments. A person skilled in the art will understand that there may be made alterations and modifications to the embodiments that are within the scope of the present invention, as also defined in the attached claims, and elements or features of the different embodiments may be combined in any configuration. Reference should also be had to the appended claims.

What is claimed is:

1-12. (canceled)

13. A back-up load retention system comprising:
a retention line configured to be connected to a load;
a counterweight unit connected to the retention line, the counterweight unit being configured to maintain a tension force in the retention line; and
a double-acting hydraulic cylinder connected to the counterweight unit, the double-acting hydraulic cylinder being configured to at least one of brake and stop the load in a case of a failure in a main lifting system.

14. The back-up load retention system as recited in claim 13, further comprising:
a plurality of sheaves,
wherein,
the retention line is connected to the counterweight unit via the plurality of sheaves.

15. The back-up load retention system as recited in claim 14, wherein the plurality of sheaves are arranged to provide a gearing ratio between a weight of the counterweight unit and the tension force in the retention line.

16. The back-up load retention system as recited in claim 13, further comprising:
at least one guide rail which is configured to support a motion of the counterweight unit.

17. The back-up load retention system as recited in claim 13, wherein,
the double-acting hydraulic cylinder comprises a rod side and a piston side, and
further comprising:
at least one hydraulic circuit arranged between the rod side and the piston side of the double-acting hydraulic cylinder, the at least one hydraulic circuit being configured to form at least one connection between the rod side and the piston side.

18. The back-up load retention system as recited in claim 17, wherein the at least one hydraulic circuit comprises at least one flow regulator which is arranged in at least one of the at least one connection.

19. The back-up load retention system as recited in claim 18, wherein the at least one flow regulator comprises a valve which is configured to isolate the rod side from the piston side if an uncontrolled falling of the load occurs.

20. The back-up load retention system as recited in claim 19, wherein the flow regulator further comprises at least one flow fuse which is configured to close or restrict at least one of the at least one connection between the rod side and the piston side if a hydraulic flow rate through the at least one flow fuse reaches a pre-determined threshold value.

21. The back-up load retention system as recited in claim 19, wherein the flow regulator further comprises a hydraulic relief valve which is configured to open at least one of the at least one connection between the rod side and the piston side when a hydraulic pressure difference between the rod side and the piston side exceeds a pre-determined threshold value.

22. The back-up load retention system as recited in claim 19, wherein the flow regulator further comprises a manually operable valve which is configured to provide a first opening of at least one of the at least one connection between the rod side and the piston side.

23. The back-up load retention system as recited in claim 19, wherein the flow regulator further comprises at least one one-way valve which is configured to provide a second opening of at least one of the at least one connection between the rod side and the piston side.

24. A lifting system comprising:
a main lifting system configured to be connected to a load; and
a back-up load retention system comprising:
a retention line configured to be connected to the load,
a counterweight unit connected to the retention line, the counterweight unit being configured to maintain a tension force in the retention line, and
a double-acting hydraulic cylinder connected to the counterweight unit, the double-acting hydraulic cylinder being configured to at least one of brake and stop the load in a case of a failure in a main lifting system of the load.

25. A back-up load retention system comprising:
a retention line configured to be connected to a load;
a counterweight configured to maintain a tension force in the retention line; and
a double-acting hydraulic cylinder connected to the counterweight, the double-acting hydraulic cylinder being configured to at least one of brake and stop the load in a case of a failure in a main lifting system.

26. The back-up load retention system as recited in claim 25, further comprising:
a plurality of sheaves,
wherein,
the retention line is connected to the counterweight via the plurality of sheaves.

27. The back-up load retention system as recited in claim 26, wherein the plurality of sheaves are arranged to provide a gearing ratio between a weight of the counterweight and the tension force in the retention line.

28. The back-up load retention system as recited in claim 25, further comprising:
at least one guide rail which is configured to support a motion of the counterweight.

29. The back-up load retention system as recited in claim 25, wherein,
the double-acting hydraulic cylinder comprises a rod side and a piston side, and
further comprising:
at least one hydraulic circuit arranged between the rod side and the piston side of the double-acting hydraulic cylinder, the at least one hydraulic circuit being configured to form at least one connection between the rod side and the piston side.

30. The back-up load retention system as recited in claim 29, wherein the at least one hydraulic circuit comprises at least one flow regulator which is arranged in at least one of the at least one connection.

31. The back-up load retention system as recited in claim 30, wherein the at least one flow regulator comprises a valve which is configured to isolate the rod side from the piston side if an uncontrolled falling of the load occurs.

32. The back-up load retention system as recited in claim 31, wherein the flow regulator further comprises at least one of,
at least one flow fuse which is configured to close or restrict at least one of the at least one connection between the rod side and the piston side if a hydraulic flow rate through the at least one flow fuse reaches a pre-determined threshold value,
a hydraulic relief valve which is configured to open at least one of the at least one connection between the rod side and the piston side when a hydraulic pressure difference between the rod side and the piston side exceeds a pre-determined threshold value,
a manually operable valve which is configured to provide a first opening of at least one of the at least one connection between the rod side and the piston side, and
at least one one-way valve which is configured to provide a second opening of at least one of the at least one connection between the rod side and the piston side.
